(19) United States
(12) Patent Application Publication
(10) Pub. No.: US 2017/0026638 A1
(43) Pub. Date: Jan. 26, 2017

(54) AUTOSTEREOSCOPIC DISPLAY SYSTEM

(71) Applicant: 8H3D LIMITED, Milton, Queensland (AU)

(72) Inventors: Kenn HARRIS, Milton (AU); Wahn RAYMER, Milton (AU)

(73) Assignee: 8H3D LIMITED, Milton (AU)

(21) Appl. No.: 15/029,946

(22) PCT Filed: Oct. 15, 2013
(86) PCT No.: PCT/AU2013/001194

§ 371 Date: Jun. 28, 2016

(30) Foreign Application Priority Data
Oct. 15, 2012 (AU) AU2012904499

(51) Int. Cl. H04N 13/04; G06T 1/20; G06T 15/00

(52) U.S. Cl. CPC H04N 13/0425; G06T 15/005; G06T 1/20; H04N 13/0404; H04N 13/0415; H04N 2213/001

(57) ABSTRACT

An autostereoscopic display system including: an autostereoscopic display including a display panel having an arrangement of pixels and an optical component mounted on the display panel, the optical component including a pattern of microlenses configured to define groups of view-dependent pixels on the display panel such that light emitted from each view-dependent pixel in a group is directed to a respective viewing position relative to the display panel, wherein the optical component is mounted on the display panel using an adjustable mounting interface configured to allow adjustment of an angular orientation of the optical component relative to the display panel and a horizontal position of the optical component relative to the display panel; and a processing system connected to the autostereoscopic display, the processing system being for causing autostereoscopic media to be displayed on the autostereoscopic display.

### BACKGROUND OF THE INVENTION

The present invention relates to an autostereoscopic display system and methods of using such a system to display three dimensional media to provide an autostereoscopic three dimensional effect.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Methods for displaying visual media using a two-dimensional display panel whilst providing a three-dimensional effect to a viewer are known. These are collectively referred to as stereoscopic methods. In general, these methods operate by presenting different offset view frames of a scene to each of the viewer's eyes, where the view frames correspond to views of the scene from respective eye positions. The viewer's brain processes the two different view frames presented to each eye such that an illusion of depth within the scene is perceived by the viewer.

One group of stereoscopic methods require the viewer to wear specialised glasses configured to ensure the appropriate view frames are presented to each eye of the viewer. Different configurations of glasses exist depending on the techniques for displaying the media. One common feature is that only two view frames can be used—one for each eye of the viewer. The need for the viewer to obtain and wear glasses is a significant downside to these methods, which greatly restricts the scenarios in which these methods can be used.

Another group of stereoscopic methods are able to provide the illusion of depth without requiring the use of specialised glasses. The display panels used in these methods generally include an optical component positioned between the display and the viewer. The optical component will typically be configured so that different eye positions will receive light from different subsets of pixels of the display. By mapping different view frames to corresponding subsets of pixels, each of the viewer's eyes will see a different view frame and perceive an illusion of depth within the scene. These methods are referred to as autostereoscopic or glasses-free 3D technologies.

A significant benefit of autostereoscopic technologies, besides the ability for glasses-free use, is that these technologies can allow more than two different view frames to be displayed simultaneously when a suitably configured optical component is used to direct light to a corresponding number of different eye points. This allows a viewer to perceive a scene from different observation angles, providing a more convincing three-dimensional effect.

The optical components used in some implementations of autostereoscopic technologies are provided with arrays of microlenses. For example, the optical components may include parallel arrays of lenticular lenses, which have been conventionally used in 3D printing applications but are receiving more attention for moving 3D media. In any case, microlens arrays will generally be configured with lens spacing parameters matching with corresponding pixel characteristics of the underlying display panel.

Microlens arrays have traditionally been oriented so that the microlenses are aligned with the pixel arrangement (i.e. the rows and columns of pixels) on the display panel. For example, parallel lenticular lenses have traditionally been aligned with vertical pixel columns. This allows different view frames to be split into different vertical lines of pixels in an interlacing process, and which in turn allow the different view frames to be directed to different eye positions by the lenses.

More recent developments have seen microlens arrays oriented at an angle relative to the pixel columns and rows. This prevents the appearance of dark vertical bands which can occur in vertically aligned microlens arrays. However, the orientation angle needs to be selected to correspond with the particular pixel characteristics of the display panel. Furthermore, it can be practically difficult to align the microlens array relative to the display panel at a precise orientation angle.

The use of an angled microlens array will also mean that the view frames now cannot be simply interlaced as adjacent vertical lines, but instead need to be mapped to particular pixels of effective view-dependent pixel groups. For example, if nine view frames are provided for a particular screen, respective pixels corresponding to each view frame will be mapped into separate pixels within groups of nine pixels, where each of the nine pixels will be visible at different eye positions relative to the display panel.

U.S. Pat. No. 7,671,889 describes autostereoscopic pixel arrangement techniques where a lenticular screen is used. This patent also provides an extensive background discussion on autostereoscopic technologies.

U.S. Pat. No. 6,801,243 discloses a method for controlling pixel addressing of a pixel display device to drive the display device as an N-view autostereoscopic display when a lenticular screen is overlaid.

US Patent Application Publication No. 2009/0073556 discloses a multi-stereoscopic viewing apparatus and particularly discusses a process of determining a specification for a lenticular lens arrangement.

### SUMMARY OF THE PRESENT INVENTION

In a first broad form the present invention seeks to provide an autostereoscopic display system including:

a) an autostereoscopic display including:
i) a display panel having an arrangement of pixels; and,
ii) an optical component mounted on the display panel, the optical component including a pattern of microlenses configured to define groups of view-dependent pixels on the display panel such that light emitted from each view-dependent pixel in a group is directed to a respective viewing position relative to the display panel, wherein the optical component is mounted on the display panel using an adjustable mounting interface configured to allow adjustment of:
   (1) an angular orientation of the optical component relative to the display panel; and,
   (2) a horizontal position of the optical component relative to the display panel; and,
b) a processing system connected to the autostereoscopic display, the processing system being for causing autostereoscopic media to be displayed on the autostereoscopic display.

Typically the mounting interface includes a frame that is fixed in relation to the display panel and a plurality of adjustable supports connected to the frame, the adjustable supports being for engaging edges of the optical component.

Typically the mounting interface includes a pair of lower supports for engaging a lower edge of the optical component, the pair of lower supports being vertically adjustable to allow adjustment of the angular orientation.

Typically the mounting interface includes at least one pair of opposing side supports, the side supports being horizontally adjustable to allow adjustment of the horizontal position.

Typically the adjustable supports are configured to allow independent adjustment of the horizontal position after the angular orientation has been adjusted.

Typically the adjustable supports are screw supports.

Typically the optical component includes a transparent substrate including surface indentations defining the pattern of microlenses.

Typically the optical component is formed as a laminate of the substrate and a layer of transparent base material.

Typically the pattern of microlenses includes an array of parallel cylindrical microlenses.

Typically the cylindrical microlenses are oriented at an orientation angle relative to vertical columns of pixels of the display panel.

In a second broad form the present invention seeks to provide a method of configuring an autostereoscopic display, the autostereoscopic display including a display panel including an arrangement of pixels and an optical component mounted on the display, the optical component including a pattern of microlenses configured to define groups of view-dependent pixels on the display panel such that light emitted from each view-dependent pixel in a group is directed to a respective viewing position relative to the display panel, the optical component being mounted on the display panel using an adjustable mounting interface configured to allow adjustment of an angular orientation and a horizontal position of the optical component relative to the display panel, wherein the method includes:
a) using a processing system connected to the autostereoscopic display, causing a first alignment pattern to be displayed on the display panel;
b) angularly aligning the optical component in accordance with the first alignment pattern by adjusting an angular orientation of the optical component relative to the display panel;
c) using the processing system, causing a second alignment pattern to be displayed on the display panel; and,
d) horizontally aligning the optical component in accordance with the second alignment pattern by adjusting the horizontal position of the optical component relative to the display panel.

Typically the first alignment pattern is configured to present a different image to a viewer depending on the angular orientation of the optical component relative to the display panel.

Typically the first alignment pattern is configured to present an image including one or more bands to the viewer when the optical component is not angularly aligned in accordance with the first alignment pattern.

Typically a number of bands in the image corresponds to a degree of angular misalignment.

Typically the method includes adjusting the angular alignment of the optical component so that no bands are visible to the viewer.

Typically the second alignment pattern includes a plurality of interlaced view frames including a central view having one or more alignment features which only become visible to a viewer at a horizontal midplane of the display panel when the optical component is horizontally aligned.

Typically the method includes adjusting the horizontal alignment of the optical component so that the alignment features become visible to the viewer at the horizontal midplane of the display panel.

Typically the second alignment pattern includes four alignment features positioned proximate to respective corners of the display panel and a fifth alignment feature positioned substantially centrally on the display panel.

In a third broad form the present invention seeks to provide a method of displaying an autostereoscopic movie on an autostereoscopic display, the autostereoscopic display including a display panel including an arrangement of pixels and an optical component mounted on the display, the optical component including a pattern of microlenses configured to define groups of view-dependent pixels on the display panel such that light emitted from each view-dependent pixel in a group is directed to a respective viewing position relative to the display panel, the method including, in a processing system:
a) receiving an autostereoscopic movie including a plurality of frames, each frame of the movie including a tiled pattern of a plurality of view frames corresponding to respective views of a three dimensional scene taken from offset view positions; and,
b) for each frame:
   i) processing the frame to extract each of the plurality of view frames;
   ii) interlacing the plurality of view frames to provide an interlaced frame by mapping pixels from each view frame to a respective view-dependent pixels on the display panel; and,
   iii) rendering the interlaced frame on the autostereoscopic display.

Typically the received autostereoscopic movie is compressed and the method further includes decompressing each frame of the movie prior to extracting the view frames.

Typically each frame is decompressed using a central processing unit of the processing system.

Typically the view frames are extracted by the central processing unit.

Typically the view frames are interlaced and the interlaced frame is rendered using a graphics processing unit of the processing system.

Typically the method further includes, in the processing system:
a) receiving additional text or image data;
b) generating three dimensional geometry using the text or image data;
c) generating a plurality of views of the three dimensional geometry corresponding to the plurality of views of each frame in the movie; and,
d) superimposing the views of the three dimensional geometry onto corresponding extracted view frames of the movie.

Typically the received autostereoscopic movie has a resolution equal to a resolution of the display panel of the autostereoscopic display.

Typically each frame of the autostereoscopic movie is processed, interlaced and rendered in real time.

In a fourth broad form the present invention seeks to provide an autostereoscopic display system, the system including:
a) an autostereoscopic display including:
   i) a display panel having an arrangement of pixels; and,
   ii) an optical component mounted on the display panel, the optical component including a pattern of microlenses configured to define groups of view-dependent pixels on the display panel such that light emitted from each view-dependent pixel in a group is directed to a respective viewing position relative to the display panel; and,
b) a processing system connected to the autostereoscopic display, the processing system being for causing an autostereoscopic movie to be displayed on the autostereoscopic display, the autostereoscopic movie including a plurality of frames, each frame of the movie including a tiled pattern of a plurality of view frames corresponding to respective views of a three dimensional scene taken from offset view positions for each frame, wherein, for each frame, the processing system is configured to:
   i) process the frame to extract each of the plurality of view frames;
   ii) interlace the plurality of view frames to provide an interlaced frame by mapping pixels from each view frame to a respective view-dependent pixels on the display panel; and,
   iii) render the autostereoscopic frame image on the display panel.

Typically the autostereoscopic movie is compressed, and the processing system includes:
a) a central processing unit configured to decompress each frame and extract each of the view frames; and,
b) a graphics processing unit configured to interlace the view frames and render the interlaced frame on the autostereoscopic display.

### BRIEF DESCRIPTION OF THE DRAWINGS

An example of the present invention will now be described with reference to the accompanying drawings, in which:—

FIG. 1 is a schematic diagram of an example of an autostereoscopic display system;

FIG. 2A is a schematic diagram of an autostereoscopic display of the autostereoscopic display system of FIG. 1;

FIG. 2B is a detail view of the autostereoscopic display at Detail B of FIG. 2A;

FIG. 2C is a cross section view of the autostereoscopic display at Section C-C of FIG. 2B;

FIG. 3 is a schematic diagram of the autostereoscopic display system of FIG. 1 showing further details of the processing system;

FIG. 4 is a schematic diagram showing an example of a plurality of views of a three-dimensional object from different viewpoints;

FIG. 5 is a schematic diagram showing an example relationship between a region of pixels underlying microlenses of an autostereoscopic display;

FIG. 6 is a schematic diagram showing an example of a viewer of an autostereoscopic display observing two different views at each eye;

FIG. 7 is a flow chart of an example of a process for aligning an optical component of an autostereoscopic display;

FIGS. 8A to 8C are schematic diagrams showing examples of images perceived by a viewer at different angular orientations of the optical component;

FIGS. 9A to 9C are schematic diagrams showing examples of images perceived by a viewer at different horizontal positions of the optical component;

FIG. 10A is an example of a first alignment pattern for use in angular alignment of the optical component;

FIG. 10B is an example of a second alignment pattern for use in horizontal alignment of the optical component;

FIGS. 11A to 11C are schematic diagrams showing an example arrangement of adjustable supports of a mounting interface for aligning the optical component, in use;

FIG. 12 is a flow chart of an example process for integrating an optical component and mounting interface into a display device;

FIG. 13 is a schematic diagram of an example of generating an autostereoscopic movie for use with the autostereoscopic display system;

FIG. 14 is a flow chart of an example process of playing an autostereoscopic movie using the autostereoscopic display system;

FIG. 15A is an example of a playlist window of player software of the autostereoscopic display system; and,

FIG. 15B is an example of a preferences window of the player software.

### DETAILED DESCRIPTION OF THE PREFERRED EMBODIMENTS

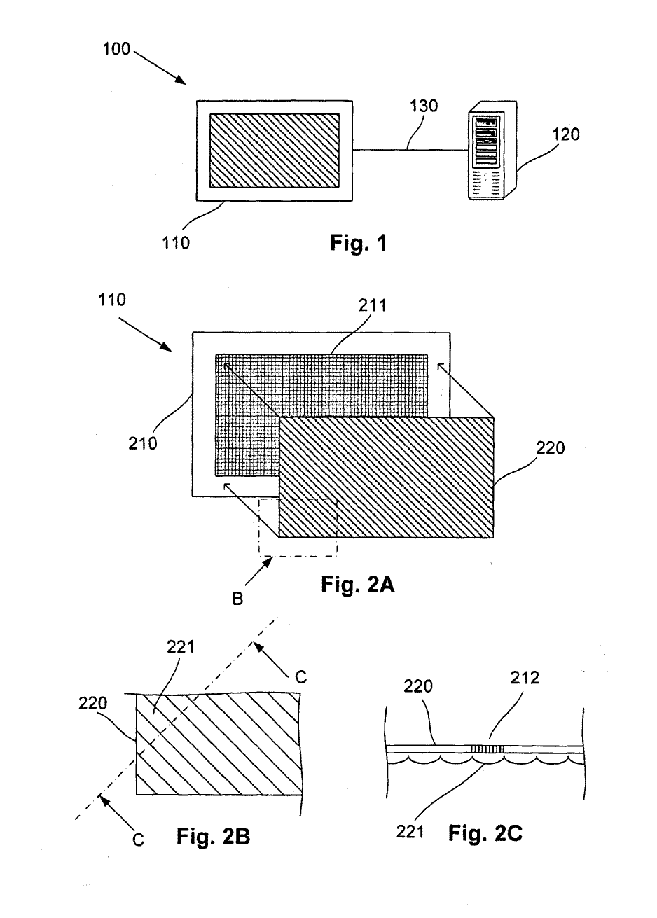

An example of an autostereoscopic display system 100 is shown in FIG. 1. In general terms, the system 100 includes an autostereoscopic display 110 and a processing system 120 connected to the autostereoscopic display 110. The processing system 120 is generally configured to cause autostereoscopic media to be rendered on the autostereoscopic display 110.

Further details of the autostereoscopic display 110 configuration can be seen in FIGS. 2A to 2C. The autostereoscopic display will typically include a display panel 210 having an arrangement of pixels 211, and an optical component 220 mounted on the display panel 210, so as to overlay the pixels 211 and optically direct light emitted from the pixels 211 in use.

The display panel 210 may be provided in the form of any pixel-based display device such as a television screen or computer monitor. Suitable display panel 210 technologies may include liquid crystal displays (LCD), light-emitting diode displays (LED), organic light-emitting diode displays (OLED), plasma display panels (PDP), thin-film transistor displays (TFT) and the like. Whilst traditional display types such as cathode ray tubes (CRT) may also be suitable, it is generally preferable to utilise a flat-screen display technology as this conveniently allows more flexible deployment of the display panel 210. Furthermore, it is preferable to use display types which have a fixed arrangement of pixels 211 for which the optical component 220 can be configured.

In general terms, the optical component 220 includes a pattern of microlenses 221 configured to focus the light emitted from the underlying arrangement of pixels 211, in such a way that light from different ones of the pixels 211 will be directed to different viewing positions relative to the display 110. Further details of this effect will be described in due course.

The pattern of microlenses 221 will typically be selected in accordance with the particular arrangement of pixels 211 provided on the display panel 210 for example, the sizes of the microlenses 221 of the optical component 220 will typically be selected based on display panel 210 characteristics such as the linear density of the pixels 211. An example configuration of microlenses 221 for a particular arrangement of pixels 211 will also be described in due course.

Closer details of the pattern of microlenses 221 of the optical component 220 depicted in FIG. 2A can be seen in FIGS. 2B and 2C. FIG. 2B shows details of a small area of the optical component 220 indicated by detailed box B in FIG. 2A. The pattern of microlenses 221 is provided in the form of an array of cylindrical microlenses 221 having a generally diagonal orientation relative to the orthogonal length and width dimensions of the optical component 220 and underlying display panel 210.

FIG. 2C shows a cross-sectional representation along section line C-C in FIG. 2B, which is drawn perpendicular to an elongation direction of the cylindrical microlenses 221. As can be seen in FIG. 2C, the array of cylindrical microlenses 221 provides a repeating pattern of convex lenses extending across the surface of the display panel.

Each of the cylindrical microlenses 221 effectively defines groups of view-dependent pixels 211 on the display panel 210, such that light from different pixels within each group will be directed to different respective viewing positions relative to the autostereoscopic display 110. An example group 212 of view-dependent pixels 211 is depicted in FIG. 2C, and it will be appreciated that the cylindrical microlens 221 overlaying the depicted group 212 will focus light from different ones of the pixels 211 within the group 212 depending on the position of a viewer relative to the cylindrical microlens 221.

In one example, the optical component 220 is formed using a transparent substrate including surface indentations defining the pattern of microlenses. The substrate may be a transparent plastic material and the surface indentations may be defined in the substrate using a rolling process. Alternatively the substrate may be glass and the surface indentations may be defined using etching or the like.

The transparent substrate may be directly mounted to the screen of the display panel 210, but in particular embodiments the optical component 220 may be formed as a laminate of the aforementioned substrate and a layer of transparent base material, such as glass, and the laminate may overlay the screen. As will be discussed in further detail below, such a laminated arrangement can be useful in allowing the optical component 220 to be moved relative to the display panel 210. The base material can provide structural rigidity to the optical component 220, so that the substrate with the microlenses 221 can be stably supported by the base material and moved relative to the display panel through movement of the base material.

An additional protective layer may also be provided over the substrate including the surface indentations. This can help to prevent accumulation of dust in the indentations or damage to the microlenses 221 during handling.

In one particular example, the optical component 220 is formed as a laminate including a base material layer formed from glass having a thickness of approximately 5 mm overlaid with a polycarbonate sheet substrate having a thickness of approximately 1 mm. The array of microlenses 221 is formed in the substrate using a repeating pattern of parallel indentations which define parallel cylindrical microlenses 221 extending across the substrate.

The optical component 220 may be mounted on the display panel 210 using a mounting interface which is configured to allow adjustment of the angular orientation of the optical component 220 relative to the display panel 210 and the horizontal position of the optical component 220 relative to the display panel 210. This will allow alignment of the array of microlenses 221 with the underlying arrangement of pixels 211. Further details of the suitable mounting interface configurations and alignment processes will be described in due course.

As discussed above, the processing system 120 will generally be configured to render autostereoscopic media on the autostereoscopic display 110. In broad terms, this is achieved by interlacing different views of a three dimensional object or scene in accordance with the arrangement of view-dependent pixels and displaying the interlaced views on the display panel 210. Further details of suitable rendering processes will be described in due course. Moreover, the processing system 120 may serve numerous additional functions to enhance the overall usefulness of the system. For example, the processing system may allow a viewer or other user to select autostereoscopic media to be displayed, obtain new autostereoscopic media, configure playback of autostereoscopic media, play non-stereoscopic (i.e. two-dimensional) media, and further functions as will be outlined in further details below.

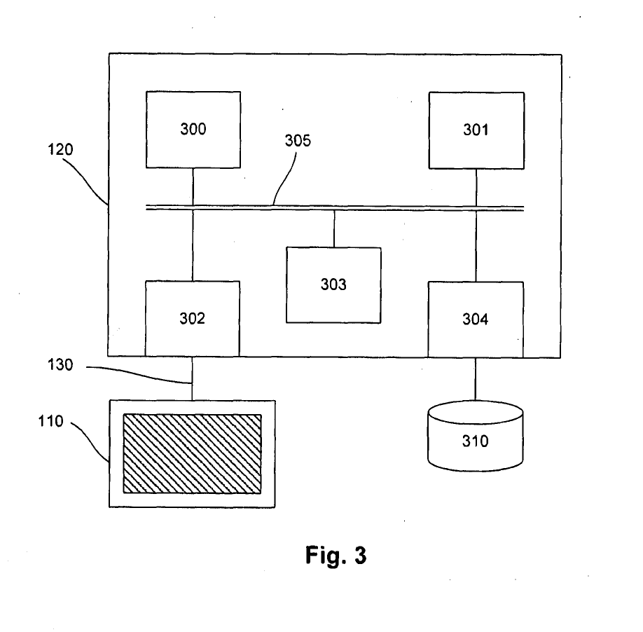

An example of a suitable processing system 120 is shown in FIG. 3. In this example, the processing system 120 includes at least one processor 300, a memory 301, a graphical output device 302, for connection to the autostereoscopic display 110, an input device 303, such as a keyboard, mouse or the like, and an external interface 304, interconnected via a bus 305 as shown. In this example, the external interface 304 can be utilised for connecting the processing system 120 to peripheral devices, such as a database 310, for example, other storage devices, a communications network, or the like. Although a single external interface 304 is shown, this is for the purpose of example only, and in practice multiple interfaces using various methods (e.g. Ethernet, serial, USB, wireless (such as Bluetooth®, Zigbee®, radio frequency networks), mobile networks or the like) may be provided.

In use, the processor 300 executes instructions in the form of application software stored in the memory 301 to allow autostereoscopic media to be displayed on the autostereoscopic display device 110, or to allow other processes to be performed, such as the selection of media to be displayed. Accordingly, it will be appreciated that the processing system 120 may be formed from any suitable processing system, such as a suitably programmed computer system, PC, web server, network server, mobile computing device or the like.

Accordingly, it will be appreciated that the processing system may be formed from any suitably programmed processing system, such as a suitably programmed PC, Internet terminal, lap-top, hand-held PC, tablet PC, slate PC, iPad™, mobile phone, smart phone, PDA (Personal Data Assistant), or other communications device. Accordingly, the processor 300 can be any form of electronic processing device such as a microprocessor, microchip processor, logic gate configuration, firmware optionally associated with implementing logic such as an FPGA (Field Programmable Gate Array), or any other electronic device, system or arrangement capable of displaying images using the techniques described below.

It may be convenient and relatively inexpensive to provide the processing system 120 in the form of an off-the-shelf general computing device having a suitable graphical processing unit for rendering autostereoscopic media directly on the display panel 210. Alternatively, processing system 120 hardware may be integrated with the autostereoscopic display 110 such that the system 100 can be provided as a self-contained unit.

In any case, the processing system 120 will control the display of graphical information on the display panel 110, and thus will be responsible for controlling the illumination of pixels 211 such that the autostereoscopic media will be presented to a viewer of the display panel 110 via the optical component 120 to provide an autostereoscopic three-dimensional effect to the viewer.

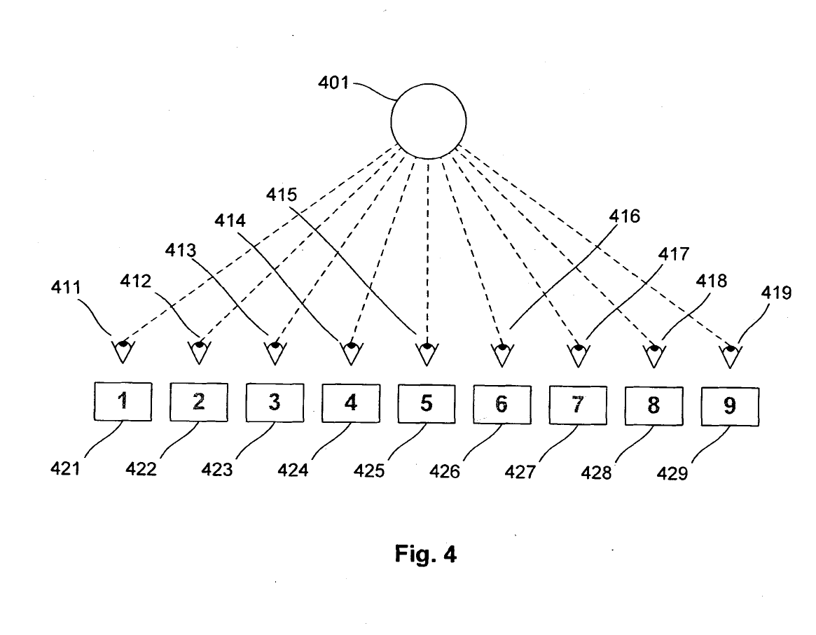

Further details of how an autostereoscopic three-dimensional effect can be provided using the system 100 will now be outlined to FIGS. 4 to 6.

As a preliminary note, it should be appreciated that methods of preparing and displaying autostereoscopic media are known in the art, and it is not the intention of the following portion of this specification to exhaustively define these known methods. Rather, the following discussion is intended to provide an outline of relevant aspects of autostereoscopic technologies in order to allow the principals of the systems and methods of the present invention to be understood in their proper context of use.

With regard to FIG. 4, an example of a process for preparing autostereoscopic media will be briefly described. It is known that media containing three-dimensional information can be captured in the form of two-dimensional views taken from different viewpoints. By presenting appropriate ones of these two-dimensional views to each of the eyes of a viewer, the viewer can perceive a three-dimensional effect despite only being presented with two-dimensional images.

For the sake of example, in FIG. 4, a three-dimensional object 401 (which may be replaced by a three-dimensional scene or any level of complexity) can be observed from a range of different viewpoints 411, 412, 413 . . . 419, and corresponding view images 421, 422, 423 . . . 429 may be captured. These view images represent the three-dimensional object 401 from different relative perspectives.

A pair of the view images 421, 422, 423 . . . 429 can subsequently be presented to the respective left and right eyes of a viewer, to allow the viewer to observe the three-dimensional object from the corresponding perspectives, and perceive a three-dimensional effect due to variations between the two view images.

For example, if a viewer's left eye was presented with the fourth view frame image 424 and viewer's right eye was presented with the fifth view frame image 425, the viewer would perceive the three-dimensional object 401 from a generally front-on perspective corresponding to the average of the two viewpoint positions. However, if the viewer's left and right eyes were presented with images 421 and 422 corresponding to the left most pair of viewpoints 411, 412, the viewer would perceive the three-dimensional object 401 from a significantly different perspective allowing additional details of the left side of the object 401 to be observed. It will be appreciated that capturing a plurality of viewpoint images allows a convincing three-dimensional effect to be perceived by a viewer, because it is possible to reproduce horizontal parallax effects as the viewer is presented with different images depending on their own viewing position.

Preferably the left and right eyes of the viewer will be presented with an adjacent pair of images, and this will generally be the case when the viewer is positioned within an optimum viewing distance range from the autostereoscopic display 110, such that different view frame images can be viewed at different horizontal positions which are spaced apart by a distance of a similar order to the average spacing between human eyes. The optimum viewing distance range will usually depend on characteristics of the autostereoscopic display 110 such as the size of the display panel 210, the particular geometry of the microlenses 221 of the optical component 220. It will be appreciated that a viewer positioned outside of the optimum viewing distance range might be presented with non-adjacent images, although this can still result in the perception of a three-dimensional effect. Ideally, the autostereoscopic display 110 characteristics will be selected to ensure that adjacent views will be perceived at the most common viewer positions relative to the autostereoscopic display 110.

In this example, nine viewpoints have been illustrated, although it will be appreciated that any number of viewpoints may be used. The selection of the number of viewpoints can involve a trade-off between the three-dimensional effect perceived by the viewer and the effective resolution of the media. The minimum number of viewpoints is of course two, as each eye of the viewer needs to be provided with a different view to provide an autostereoscopic effect. Increasing the number of views can allow a more convincing three-dimensional effect to be provided to the viewer by presenting different pairs of views to the viewer's eyes at different viewing angles relative to the autostereoscopic display 110. However, increasing the number of views will also have an impact on the effective resolution of the three-dimensional media as perceived by the viewer, given that the number of pixels 211 on the display panel 210 remains fixed and only the pixels 211 corresponding to one of the views will be seen by each eye of the viewer.

The images shown in FIG. 4 can be prepared in several ways. Views of physical three-dimensional objects or scenes may be captured using known imaging and video capture devices such as cameras from each viewpoint to thereby provide view images or view movies at each viewpoint. Alternatively the images may be computer generated using known three-dimensional graphics techniques. For instance, a computer representation of a three-dimensional object or scene may be generated using commercially available three-dimensional graphics software, and this may be used to prepare the required viewpoint images from virtual viewpoints relative to the computer generated objected or scene. Again, this can allow the viewpoint images to be obtained, and movies may be captured for each of the viewpoints to result in view movies corresponding to each viewpoint.

Irrespective of the manner of obtaining the view images or view movies, these will form the basis of the autostereoscopic media content to be displayed to the viewer. Autostereoscopic technologies are primarily concerned with techniques of ensuring these view images or view movies are correctly presented to the viewer's eyes when these are positioned in corresponding positions relative to an autostereoscopic display panel 110, as discussed above. This is achieved by interlacing the view images or frames of a view movie to prepare a single image or movie frame suitable for rendering on the pixels 211 of the display panel 210, such that the pattern of microlenses 221 will direct light from the underlying pixels 211 to thereby allow the viewer's eyes to observe light from particular ones of the pixels corresponding to the views to reproduce the three-dimensional effect.

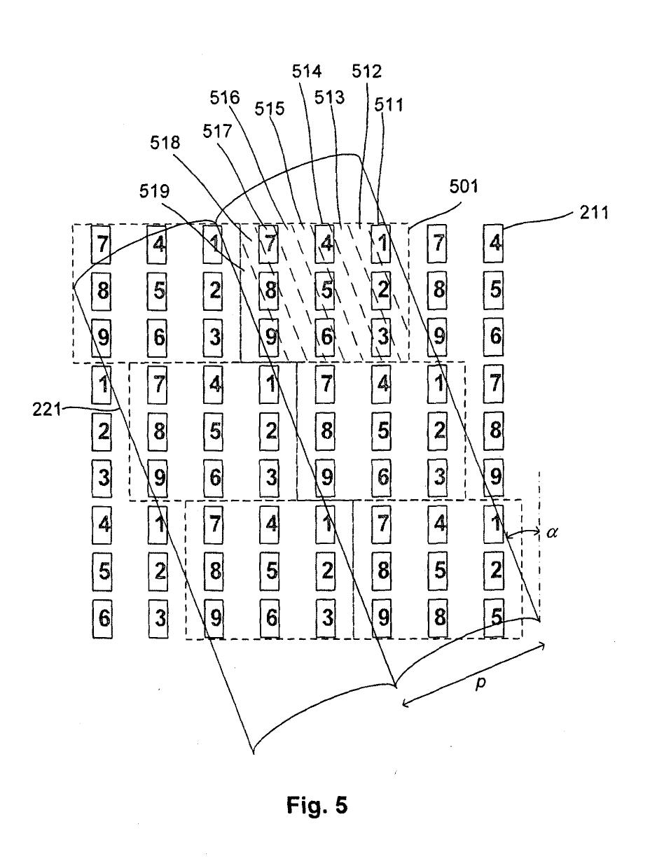

FIG. 5 depicts a close-up example a relationship between cylindrical microlenses 221 of a suitable optical component 220 and pixels 211 of a display panel 210. As shown, the pixels 211 are arranged in a grid arrangement having horizontal rows and vertical columns. The total number of pixels in a horizontal row will define the horizontal resolution of the display panel 210 and the total number of pixels 211 in a vertical column will define the vertical resolution of the display panel 210.

The close-up example in FIG. 5 focuses on a small region of the display panel 210 spanning 8 pixels horizontally and 9 pixels vertically. It will be understood that the relationships between the pixels 211 and the cylindrical microlenses 221 illustrated in this example will repeat across the entire surface of the display panel 210 in a generally similar fashion. It should be appreciated that the pixels 211 and microlenses 221 are depicted schematically and the arrangement shown in FIG. 5 is not intended to be limiting.

The cylindrical microlenses 221 are positioned above the pixels 211 in such a way as to define groups 501 of view-dependent pixels 211. Continuing from the example of FIG. 4, nine views are provided for, and thus each group 501 includes nine view-dependent pixels 211 labelled 1 through 9, corresponding with respective view numbers in FIG. 4.

View regions 511, 512, 513 . . . 519 for one of the groups 501 underlying one of the cylindrical microlenses 211 are indicated by parallel dashed lines. Light from each of the view regions 511, 512, 513 . . . 519 will be focused to different viewing positions relative to the autostereoscopic display 110. Given that human eyes are offset horizontally, horizontal differences in the positions in the view regions will ensure different views are provided to different ones of the viewer's eyes.

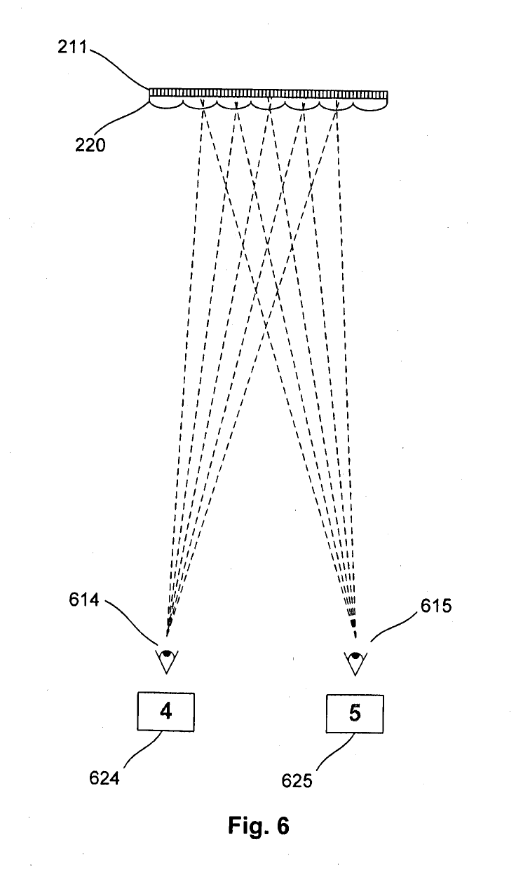

FIG. 6 shows an example of a viewer's eyes positioned at horizontally offset viewpoints relative to the autostereoscopic display 110, such that an image 624 corresponding to view number 4 is observed at the viewer's left eye 614 and an image 625 corresponding to view number 5 is observed at the viewer's right eye 615, due to the respective focussing of light from pixels 211 corresponding to those views. This is due to the positioning of different ones of the pixels relative to the view regions 511, 512, 513 . . . 519.

For instance, turning back to FIG. 5, view region 514 will mainly focus light from a pixel corresponding to view number 4 to the position of the viewer's left eye 614. Accordingly, a view image or frame of a view movie for view number 1 of a three dimensional object or scene would be mapped to pixels corresponding to view number 4 so that the image 624 is presented to the position of the viewer's left eye. Similarly, view region 515 will mainly focus light from a pixel corresponding to view number 5 to the position of the viewer's right eye 615. A view image or frame of a view movie for view number 5 of a three dimensional object or scene would be mapped to pixels corresponding to view number 5 so that the image 625 is presented to the viewer's right eye 615. Mapping of each of the view images or frames of view movies to view-dependent pixels would take place in a similar fashion.

It will be understood that such an arrangement of groups of view-dependent pixels in relation to the cylindrical microlenses 221 can allow a plurality of views to be provided to a viewer depending on the positions of their eyes relative to the autostereoscopic display.

The cylindrical microlenses 221 may be oriented at an angle relative to the horizontal and vertical directions of the autostereoscopic display panel 110. This can be beneficial in helping to prevent dark vertical bands which may appear to a viewer if the cylindrical microlenses 221 are arranged purely vertically, due to the cylindrical microlenses 221 focusing on regions between columns of pixels 211 from some viewpoints.

Furthermore, the angled orientation allows a plurality of views to be provided for whilst allowing the necessary reduction in effective resolution of the view images or frames of view movies to be shared between the horizontal and vertical directions. In contrast, vertically arranged microlenses require interlacing to be carried out by placing vertical one-pixel-wide strips from each view, such that a nine view autostereoscopic display would involve reducing the natural horizontal resolution of the display panel 210 by a factor of nine. As seen in FIG. 5, the angled orientation of the cylindrical microlenses allows each of the effective horizontal resolution and the vertical resolution to be reduced from the respective natural resolutions of the display panel 210 by only a factor of three.

As mentioned above, the parameters of the pattern of microlenses 221 will generally be selected to match the arrangement of pixels 211 on the display panel 210. Two important parameters are the orientation angle α (in this case measure from vertical) and the microlens pitch p, and selection of these two parameters will be largely dictated by horizontal and vertical spacing between pixels and the number of views to be provided by the autostereoscopic display. It will be appreciated that these parameters will vary depending on the particular display panel 210 that is used, and particularly its display size and resolution. The particular curvature of the microlenses 221 may also be varied to adjust the focal point of the microlenses and to set an optimal viewing distance from the display panel 210 at which horizontal distances separating different observed views will be approximately equal to the separation between an average viewer's eyes.

In any case, it is noted that techniques for selecting such microlens parameters are known, and specialised manufacturers of microlenses 221 exist, from whom suitable optical components 220 can be obtained to suit particular display panel 210 and viewing requirements.

It will be appreciated that the positioning and orientation of the cylindrical microlenses 221 relative to the groups 501 of view dependent pixels 211 will impact whether the interlaced views are correctly displayed to the viewer's eyes at different viewing positions.

Angular misalignment of the cylindrical microlenses 221 relative to the arrangement of pixels 211 on the display panel 210 can prevent the microlenses 221 from focusing view dependent pixels 211 for a single view to a particular viewing position. Significant angular misalignment may result in the viewer observing pixels 211 corresponding to different view numbers at different vertical positions on the display panel 210, which will typically results in distorted three-dimensional image being observed by the viewer.

An offset in horizontal position of the optical component 220 relative to the arrangement of pixels 211 on the display panel 210 can cause the viewer to observe the three-dimensional object or scene from perspectives that do not correspond with the viewer's position relative to the display panel 210, which can compromise the viewer's perception of the three-dimensional effect.

In view of the above, the optical component 220 may be mounted on the display panel 210 using an adjustable mounting interface, which is configured to allow the adjustment of the angular orientation of the optical component 220 relative to the display panel 210 and the horizontal position of the optical component 220 relative to the display panel 210. The angular and horizontal alignment can then be adjusted with reference to alignment patterns which can be rendered on the display panel 210 by the processing system 120.

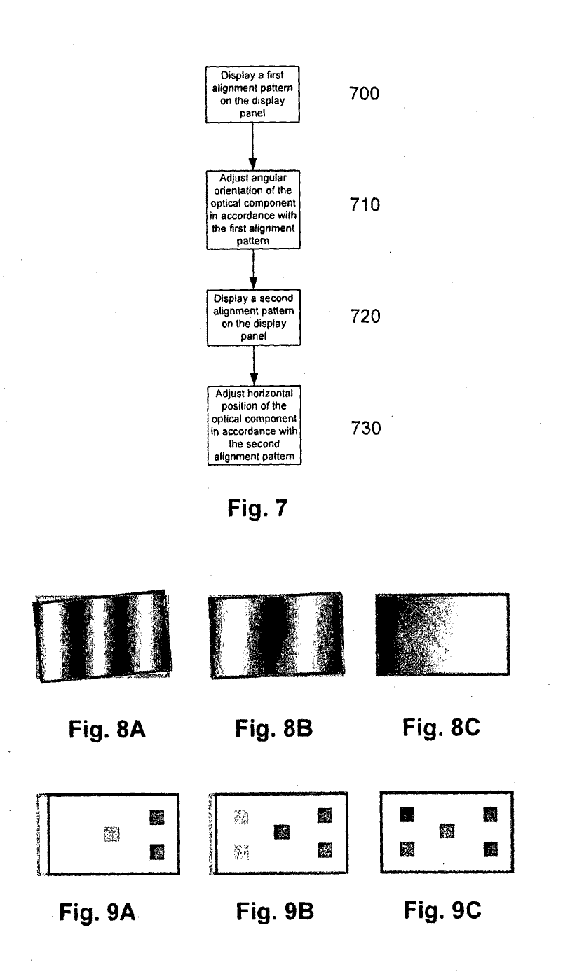

An example alignment process is outlined in FIG. 7. In step 700, a first alignment pattern is displayed on the display panel 210. The angular orientation of the optical component 220 is then adjusted in accordance with the first alignment pattern at step 710, to thereby angularly align the optical component 220 with the display panel 210.

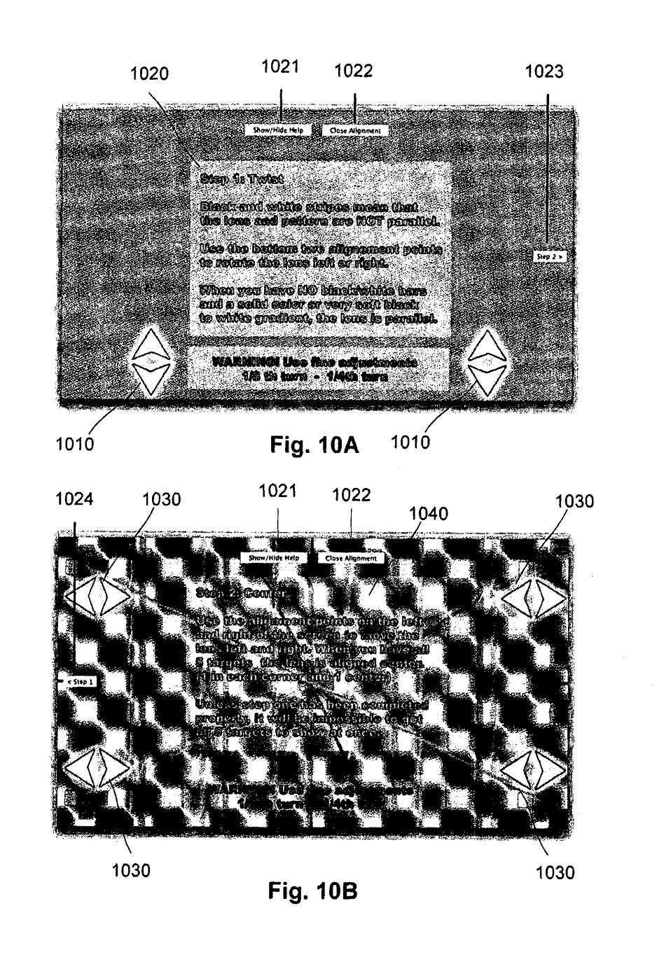

The first alignment pattern will usually be configured to present a different image to a viewer depending on the angular orientation of the optical component 220 relative to the display panel 210. An example of a suitable first alignment pattern is shown in FIG. 10A. Typically, the first alignment pattern will include interlaced views of sequentially alternating colours. For example, the first alignment pattern may include nine interlaced views, in which odd numbered views consist of a solid black image and even numbered views consist of a solid white image.

FIGS. 8A to 8C show examples of the effective image perceived by a viewer at different orientations of the optical component 220 relative to the display panel 210. When the optical component 220 is rotated, the viewer will see different black to white patterns that repeat across the surface. When the optical component 220 is correctly aligned with the arrangement of pixels 211 on the display panel 210, the viewer should observe a substantially solid black or white image or an image having a smooth horizontal black to white gradient.

The presence of black and white gradient bands or vertical variations in colour will indicate angular misalignment, and when these effects are observed the viewer (or another user performing the adjustments) should adjust the angular orientation of the optical component 220 until those effects are substantially eliminated. The number of bands observed by the viewer may be correlated with the degree of angular misalignment, such that the adjustment can be performed in a direction which reduces the number of bands visible to the user. The greater the number of black to white gradient bands, the further the rotation is from parallel alignment with the lens. For instance, FIG. 8A a case where the optical component 220 is misaligned to the extent that two dark bands are visible, whilst in FIG. 8B the degree of misalignment angle has been roughly halved, as indicated by the fact that only one dark band is now visible. Finally, FIG. 8C shows a smooth gradient which is indicated of correct angular alignment.

Once the angular orientation of the optical component 220 has been aligned, a second alignment pattern will be displayed on the display panel 210 at step 720. Then, at step 730, the horizontal position of the optical component 220 relative to the display panel 210 can be adjusted in accordance with the second alignment pattern, to thereby horizontally align the optical component 220 with the display panel 210.

The second alignment pattern will include a plurality of interlaced views including a central view having one or more alignment features which only become visible to a viewer when the viewer's eyes are positioned at or near a horizontal midplane of the display panel 210, when the optical component 220 is horizontally aligned. In other words, the alignment features are only provided in the view mapped to pixels which will be focussed by the optical component 220 from a generally central viewing position relative to the display panel 210 and optical component 220. If the viewer is at a central viewing position and the alignment features are not visible, then this will indicate that the optical component 220 is not correctly aligned with the view-dependent pixels 211. The second alignment pattern may also include interlaced respective views of a three-dimensional object or scene to thereby test the three-dimensional effect perceived by the viewer.

An example of a suitable second alignment pattern is shown in FIG. 10B. In this example, the second alignment pattern include three-dimensional foreground and background features to confirm depth is perceived by the viewer, but the most important features are five colour registration boxes positioned in the top left, top right, bottom left, bottom right and centre of the screen, which provide the alignment features. These registration boxes are only present in the centre view image and are turned off in all other views. Accordingly, only pixels 211 corresponding to the centre view will display the boxes, and thus the boxes will only be visible from a central position relative to the optical component 220. When the optical component 220 is adjusted horizontally, the viewer will see the registration boxes become visible as the microlenses 221 become more centred over pixels 211 corresponding to the centre view.

FIGS. 9A to 9C show an example of the images presented to a viewer positioned centrally to the display panel 210 as the horizontal position of the optical component 220 is adjusted. FIG. 9A shows a significantly off-centre position where only some of the boxes are visible, corresponding to a horizontal offset equal to half of the microlens pitch p. Whilst FIG. 9B shows an improved in horizontal alignment, such that all five boxes can be made out, it is clear that the left boxes are not fully visible and thus there is still some misalignment, corresponding to a horizontal offset equal to a quarter of the microlens pitch p. In FIG. 9C, all five of the boxes are fully visible, indicating that the microlenses 221 are centred over the pixels 221 corresponding to the centre view including the boxes, and thus indicating that the optical component 220 is now horizontally aligned.

The use of four boxes proximate to respective corners of the display panel and a fifth box positioned substantially centrally on the display panel can also further allow confirmation of correct angular alignment, since if the microlenses 221 are angularly misaligned, upper or lower ones of the boxes may not be visible to the viewer. If correct angular and horizontal alignment has been achieved, all five boxes should be equally visible.

It is noted that existing alignment methods for conventional 3D display systems generally only provide a single alignment pattern with which a lens is aligned. However, alignment can be very difficult because the user needs to simultaneously ensure the lens is both parallel to the alignment pattern and horizontally centred over the alignment pattern. Finding both the amount of angular rotation and the horizontal centrepoint of the lens over the alignment pattern at the same time was a tedious process. However, by using two alignment patterns and providing a capability to separately adjust angular orientation and horizontal position of the optical component 220, this allows angular and horizontal alignment issues to be addressed accurately in separate steps.

As discussed above, alignment of the optical component 220 can be facilitated using an adjustable mounting interface. The adjustable mounting interface may include a frame that is fixed in relation to the display panel and a plurality of adjustable supports connected to the frame, where the adjustable supports are for supporting the optical component 220.

The mounting interface will typically be configured so that the optical component 220 will be held flush against the screen of the display panel 210 but will be able to move laterally and rotationally relative to the screen of the display panel 210. The adjustable supports can be positioned at edges of the optical component 220, whereby adjustment of selected ones of the adjustable supports can be used to adjust the angular orientation or position of the optical component.

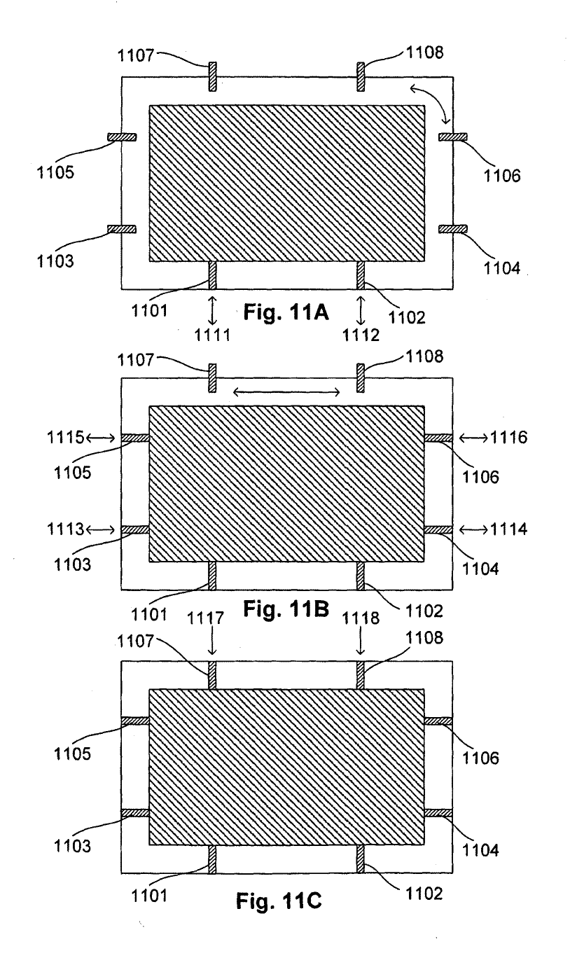

An example arrangement of adjustable supports and examples of their use to align the optical component 220 are shown in FIGS. 11A to 11C. In these examples, the adjustable supports are screw supports 1101, 1102, 1103, 1104, 1105, 1106, 1107, 1108 which engage with suitable threaded holes in the frame of the mounting interface, contacting an edge of the optical component 220 at an inner end and extending outwardly from the screen of the display panel 210 at an opposite outer end. Each screw support can be moved along its axis by rotating the screw support, typically by turning the outer end. The outer end of the screw support may be adapted to allow rotation using a suitable tool such as an allen key or a screwdriver or may alternatively be adapted to allow rotation by hand without requiring a tool.

In any case, movement of selected ones of the screw supports can be used to move the edges of the optical component 220 at the contacting positions, and this can allow the overall angular orientation and horizontal positioning of the optical component 220 to be adjusted as part of the above discussed alignment process.

Before commencing alignment, each of the screw supports should be partially unscrewed so that the optical component 220 is free to move laterally relative to the display panel throughout the alignment process. Typically the screw supports will be prevented from becoming completely unscrewed. Throughout the alignment process, the screw supports will be adjusted with reference to the image presented to a viewer by the first and second alignment patterns. Typically, the viewer will be the same person performing the alignment process, and therefore adjustments may be performed iteratively, with the viewer checking the alignment pattern image by standing as close to the centre of the display panel 110 as possible at an optimal viewing distance and then adjusting screw supports accordingly. Following this viewer will repeat the steps of checking the alignment pattern image and adjusting selected ones of the screw supports until satisfactory alignment is achieved.

With reference to FIG. 11A, a pair of lower screw supports 1101, 1102 are provided for supporting a lower edge of the optical component 220. The lower screw supports 1101, 1102 are vertically adjustable in the direction of arrows 1111, 1112 to allow adjustment of the angular orientation of the optical component 220.

Turning back to 10A, it will be seen that the first alignment pattern may include visual guides 1010 indicating the positions of the lower screw supports that should be used in the angular alignment process. The first alignment pattern may also include written instructions 1020 to assist the user in carrying out the alignment process. On screen options may also be provided to toggle between showing/hiding the instructions at button 1021, closing the alignment pattern screen at button 1022, and proceeding to the second alignment pattern at button 1023.

During angular alignment, the remaining screw supports 1103, 1104, 1105, 1106, 1107, 1108 should be partially unscrewed so as to not contact with other edges of the optical component 220 and thus not interfere with the angular alignment.

Once the angular orientation of the optical component 220 has been set using the lower screw supports 1101, 1102, the horizontal adjustment of the optical component 220 can commence. This part of the alignment process will involve movement of side screw supports 1103, 1104, 1105, 1106, which are horizontally adjustable in the direction of arrows 1113, 1114, 1115, 1116. It will be appreciated that the horizontal position of the optical component 220 can be adjusted independently of the angular orientation, so long as the lower screw supports 1101, 1102 remain in the position established during the angular alignment.

With reference again to FIG. 10B, the second alignment pattern may also include visual guides 1030 indicating the positions of the side screw supports that should be used in the horizontal alignment process. The second alignment pattern may also include written instructions 1040 to assist the user in carrying out the alignment process, and on-screen option buttons similar to those discussed for FIG. 10A, including button 1024 for returning to the first alignment pattern in case it becomes apparent that further angular adjustment may be required.

The side screw supports 1103, 1104, 1105, 1106 may be arranged in opposing side support pairs, for instance, a pair of lower side supports 1103, 1104 and a pair of upper side supports 1105, 1106. Typically, adjustment of the horizontal position will be achieved by gradually moving side screw supports of each pair on one side only, which the side screw supports of each pair on the other side are left partially unscrewed such that they are not in contact with an edge of the optical component 220. This allows horizontal movements of the side screw supports on one side of the optical component 220 to be used to progressively urge the optical component in a horizontal direction to provide the necessary horizontal adjustments.

For instance, left side screw supports 1103, 1105 may be moved inwardly to engage with the left side of the optical component 220 and urge the optical component to the right, until the alignment features of the second alignment pattern become visible to a centrally positioned viewer. Once the optical component 220 is horizontally aligned in accordance with the second alignment pattern, the right side screw supports 1104, 1106 can be screwed inwardly to engage the other side of the optical component 220 and thus retain the optical component 220 in its horizontal position.

As shown in FIG. 11C, an optional final step is to screw upper screw supports 1107, 1108 into engagement with the upper edge of the optical component 220. Whilst these upper screw supports 1107, 1108 are not strictly necessary for the actual alignment of the optical component 220, these can be used to securely retain the optical component 220 against vertical movement during transport of the autostereoscopic display, for instance. It will be appreciated that only six of the screw supports are used in the actual alignment of the microlens in this example.

It should be noted that the angular alignment of the optical component 220 needs to be completed properly before attempting horizontal alignment, as horizontal alignment will not be possible without the microlenses 221 being parallel with the underlying groups of view-dependent pixels.

Proper alignment will typically require fine adjustments of the screw supports. Screw support rotation increments of ⅛th or ¼th of a turn will generally be recommended, as making large turns will move the pattern of microlenses 221 considerably relative to the underlying pixels 211. The microlenses 221 are typically very small, and thus large movements can make it difficult to reliably converge on an aligned position.

Once satisfactory alignment has been achieved, it is important to ensure that all of the screw supports snugly engage with respective edges of the optical component 220 to securely retain it in place. However, care should be taken to avoid over-tightening as this may result in warping of the optical component 220 which could distort the images perceived by a viewer. It will be understood that the use of an optical component 220 including a relatively thick layer of glass or other suitable base material will help to minimise deflections of the optical component 220 even in the event of some over-tightening.

It will be appreciated that the above discussed arrangement of screw supports will be equally applicable to supporting and aligning of the optical component 220 when the display panel 210 is operated in a portrait orientation, as opposed to the landscape orientation that has been depicted in the example.

Whilst it is possible to incorporate an adjustable mounting interface including screw supports as discussed above into a new display panel 210 during manufacture, it may also be convenient to integrate an optical component 220 and a suitable adjustable mounting interface into an existing display panel 210 to thereby convert it into a suitable autostereoscopic display 110.

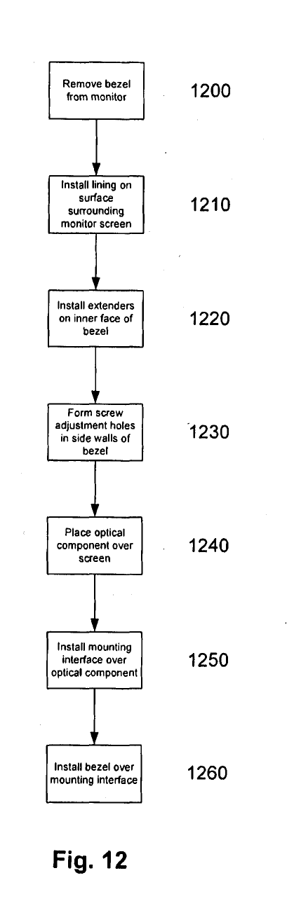

FIG. 12 shows an example process for modifying a display panel 210 in the form of an LCD monitor, or the like. In step 1200, the outer bezel surrounding the screen of the monitor is first removed. This may also necessitate the removal of a rear cover of the monitor to obtain access to the bezel attachment points which are usually accessible from the rear of the screen.

After removing the bezel, a lining is installed on a surface surrounding the screen at step 1210. The lining may suitably be provided in the form of one or more layers of tape. At step 1220, extender components are installed on the inner face of removed bezel. These extender components (which may also be referred to as standoffs) are for offsetting the bezel away from the screen by a distance selected to accommodate the added thickness of the optical component 220 and adjustable mounting interface.

At step 1230, screw adjustment holes are formed in each of the side walls of the bezel, to align with the screw supports that will be provided in the mounting interface. These holes are provided to allow access to outer ends of the screw supports to facilitate their adjustment. Typically the mounting interface will be used as a guide for determining the required positions of the screw adjustment holes.

Other modifications to the bezel may also be required to prevent interference with the mounting interface, although this will depend on the particular monitor configuration. For instance, it may be necessary to remove plastic tabs from the bezel or remove electrical components associated with IR receivers.

With the monitor laying down on its rear, the optical component 220 is then placed over the screen at step 1240, resting on the lining surrounding the screen. At this stage, bumper components may also be provided along edges of the optical component 220 to act as an intermediate interface between the screw supports and the edges of the optical component 220 when the screw supports engage the edges during later alignment processes.

Following this, at step 1250 the mounting interface can be installed over the optical component 220. As mentioned previously, the mounting interface will typically include a frame and screw supports for engaging with edges of the optical component 220. At this stage the screw supports should be unscrewed so as to not contact the edges of the optical component 220.

The bezel is then installed over the mounting interface at step 1260. The mounting interface may be retained in place using the existing bezel attachment points, and thus might only be secured in relation to the screen when the bezel is reattached to the monitor, via the extender components.

Following this integration process the optical component 220 can then be aligned and the autostereoscopic display 110 will be ready for use.

Further details of the operation of the processing system 120 will now be described. The processing system 120 renders interlaced images or frames of movies on the autostereoscopic display 110 in use. This is typically facilitated by having the processing system 120 execute player software which is configured to play movies or display images in a suitable format for rendering on the autostereoscopic display 110.

As discussed previously, an autostereoscopic effect is provided by having different views of a three-dimensional object or scene presented to different viewing positions relative to an autostereoscopic display 110. The player software will therefore be required to receive autostereoscopic media including a plurality of views, carry out processes to interlace the views in a proper format for presentation on the autostereoscopic display 110 in view of its particular configuration, and then render the interlaced views on the autostereoscopic display 110.

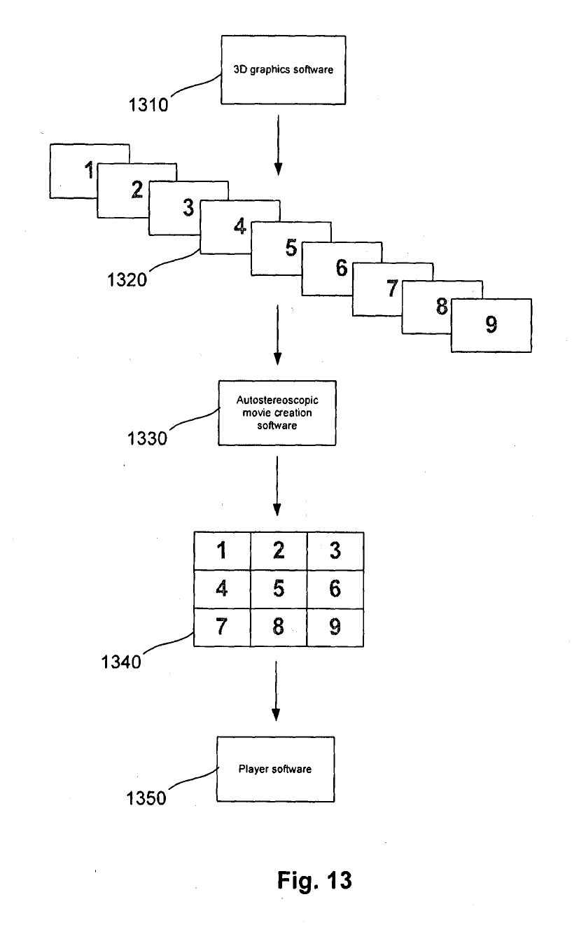

An illustrative process for providing an autostereoscopic movie to the player software is shown in FIG. 13.

Autostereoscopic media can be generated or obtained from a range of different sources. Renderings from 3D graphics software 1310, such as industry 3D ray tracer software including as Cinema 4D, 3D Studio and Maya, can be used to prepare view movies 1320, i.e. separate movies captured from different virtual eye positions relative to the rendered object or scene. These view movies can be imported into autostereoscopic movie creation software 1330 and converted into an autostereoscopic movie 1340 in a suitable format for playback by the player software 1350.

Graphical content can also be generated in other graphics software such as Photoshop. Generated graphics, layered files and movies can also be imported into the autostereoscopic movie creation software and given depth, animated and output directly to autostereoscopic movies. In this case, the creation software 1330 can output movies using a user selected number of views.

It will be appreciated that the autostereoscopic movie creation software 1330 provides a user with the ability to import and render autostereoscopic movies ready for the player software from multiple sources or using its own built in tools. Although the creation software 1330 may be executed on the same processing system 120 as the player software, it is more usual to prepare autostereoscopic movies on a separate processing system and then provide these to the processing system 120 of the autostereoscopic system 100.

The autostereoscopic movie 1340 is preferably output from the autostereoscopic movie creation software 1330 in a format where each frame of the movie includes a pattern of tiles from each view of the three-dimensional object or scene. For instance, for a nine-view autostereoscopic movie, the creation software may receive nine separate view movie files and process these view movies by tiling them into a single autostereoscopic movie 1340 file. An example of such a tiling process is depicted in FIG. 13, where the nine view movies 1320 are arranged in a 3×3 pattern in the autostereoscopic movie 1340.

The autostereoscopic movie 1340 will preferably be prepared to have a resolution matching the resolution of the autostereoscopic display 110. This facilitates straightforward mapping of view pixels to the view-dependent pixels on the autostereoscopic display 110. Accordingly, the tiling process may require each view movie 1320 to undergo a change in resolution so that the final tiled autostereoscopic movie 1340 is provided at the appropriate resolution.

The tiled autostereoscopic movie 1340 will typically be compressed using standard video compression techniques when output from the creation software, in the interest of storage efficiency.

By providing the autostereoscopic movie 1340 in a tiled format, without interlacing, this allows the tiled autostereoscopic movie 1340 to be interlaced by the player software in different ways to suit different configurations of autostereoscopic display 110, whereas a pre-interlaced movie would typically only be playable on displays having particular configurations, since interlacing will be dependent on the arrangement of view-dependent pixels 211 on a particular display.

It will be appreciated that a tiled autostereoscopic movie 1340 can be compressed in a more efficient manner compared to compression of a pre-interlaced movie, as interlacing will tend to remove large repeated areas of graphical information which is most efficiently compressed.

Furthermore, when a tiled stereoscopic movie 1340 is compressed, visual noise associated with video compression is spread evenly across the autostereoscopic display 110 when the view frames are extracted and interlaced following decompression. If the movie was pre-interlaced and then compressed, any compression noise would remain unchanged when displayed on the autostereoscopic display 110 and would be easily noticeable by the viewer. However, when interlacing takes place after compression, compression noise will no be longer noticeable by the viewer.

The player software 1350 can then take the autostereoscopic movie 1340 converted or generated by the creation software, interlace it in accordance with the autostereoscopic display 110 configuration and render the interlaced movie on the display 110.

The player software 1350 is capable of playing autostereoscopic movies on displays 110 in portrait or landscape orientations. Whilst the player software 1350 is clearly adapted for playing three-dimensional content, it is also able to display two-dimensional movies or two-dimensional pictures from other sources, should it be desirable to also display two-dimensional content on the same display 110.

In general terms, the player software will receive an autostereoscopic movie, and then for each frame of the movie, the player software will cause each of the views to be extracted from the tiled views and then interlaced to provide an interlaced frame which is in turn rendered on the autostereoscopic display 110.

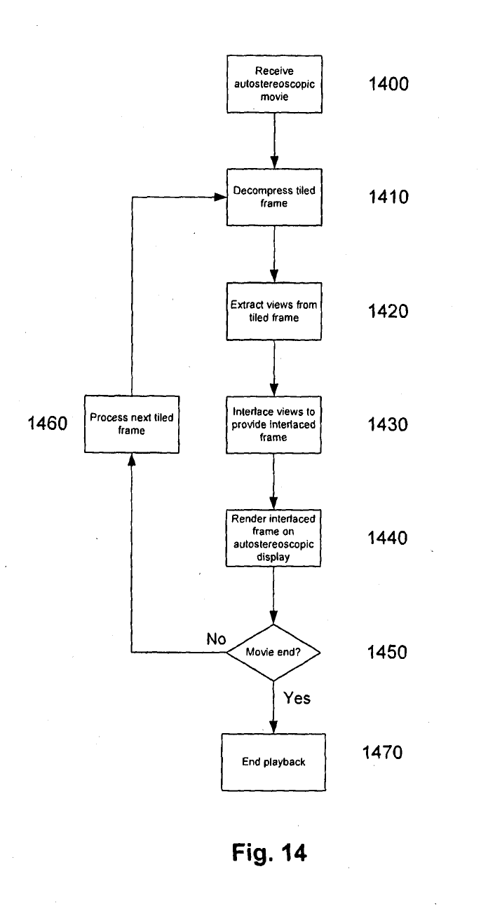

An example of further detailed process steps carried out by the player software in order to play an autostereoscopic movie prepared in the manner discussed above will now be outlined with reference to FIG. 14.

In step 1400 an autostereoscopic movie is received. Each frame of the movie includes a tiled pattern of a plurality of views, and in this example the movie is compressed using a known video compression technique, such as the H.264 video compression standard. It will be appreciated that any compression technique can be used, although it will generally be desirable to use techniques which can be decompressed in a computationally efficient manner.

Each frame of the autostereoscopic movie will then be processed in turn until the end of the movie. At step 1410, a frame of the autostereoscopic movie is decompressed. Following this, the views making up the frame are extracted at step 1420. This will typically require knowledge of the number of views tiled in the autostereoscopic movie and the tiling pattern used to prepare the autostereoscopic movie, to ensure the views are correctly processed in subsequent steps. This information can be predefined as part of the player software, or accessed from a remote location, such as a database. In one example, different patterns could be defined, with the correct pattern being selected based on information provided by the user, such as an identifier or serial number associated with the optical component.

The views are then interlaced at step 1430 to provide an interlaced frame suitable for displaying of the autostereoscopic display 110. The particular interlacing process will be dependent on the arrangement of pixels 211 on the display panel 210, and the groups of view-dependent pixels due to the microlenses 221 of the optical component 220 overlaying the pixels of the display panel 210. The interlacing process of the player software may be fixed to only apply to a particular autostereoscopic display 110 configuration, but more preferably the player software will allow configuration parameters to be entered to allow the interlacing process to be tailored to different configurations.

In any event, the interlacing processing generally includes mapping pixels from each view to a respective pixel corresponding to that view in an appropriate group of view-dependent pixels. Once the interlaced frame has been prepared, this can be rendered on the autostereoscopic display 110 at step 1440. If it is determined that the movie has not ended at step 1450, the process continues with the next frame at 1460, and will repeat until the end of the movie, at which time playback of the movie will end at step 1470.

Preferably, the frame processing steps in the above discussed process will be carried out by the processing system in real time. One manner of facilitating real time frame processing during playback is to distribute processing tasks between a central processing unit (CPU) and a dedicated graphical processing unit (GPU) of the processing system.

In one example, as the autostereoscopic movie plays the player software causes the CPU to decompress the frames and return the tiled views to the player software. The player then utilises the GPU, for instance via an OpenGL application programming interface (API) or the like, to extract each tiled view, and send it through a custom-built shader that prepares the interlaced frame by drawing and masking each view and then renders the interlaced frame on the screen, in real time.

By utilizing the CPU to decompress video and utilising the GPU, which is specially adapted for carrying out three-dimensional mathematical operations and graphical rendering, to perform interlacing and rendering directly, it is possible to process the nine-view autostereoscopic movie frames in real time using modest computing hardware. Testing has demonstrated that frame processing rates in excess of the standard 24 frames per second used in most movie recording formats can be obtained an off-the-shelf Apple Mac Mini computer system. It is noteworthy that this performance was achieved using standard H.264 HD movie formatting, such that the autostereoscopic movie was packaged in a form that can be readily decompressed without requiring specialised decompression codecs.

The player software can also provide for additional useful functionalities beyond the playback of autostereoscopic movies. For example, additional data or text can be displayed on screen by the player simultaneously with the playback of autostereoscopic movie content.

As discussed, the player software may utilise the GPU and the OpenGL API for rendering. The OpenGL API allows graphics, model and texture data to be buffered directly to the GPU, and the player software may include tools for rendering text, images and transformations.

In one example, the player software can receive input text data along with autostereoscopic movie, then construct textures using the text and superimpose this on three-dimensional geometry buffered directly on the GPU. Accordingly, while the movie is playing, text or image data can be statically displayed or animated across any point of the screen and even continue scrolling or playing between movies.

The above discussed configuration of the player software and resulting playback process can provide some advantageous results compared to conventional autostereoscopic playback techniques.

Given that the player software can interlace and render an autostereoscopic movie from the view frames in real time, this enables functionalities which would not otherwise be available using pre-interlaced movies. A pre-interlaced movie with added text is static and will always be the same. On the other hand, variable data, such as user-defined text and images, can be added into an autostereoscopic movie prior to interlacing and rendering. This allows content to be customised and reused rather than needing to generate new pre-interlaced movie content each time the user requires different data to accompany a movie.

The player software only receives the data from each view that is necessary for forming the interlaced frames by receiving the views in a tiled autostereoscopic movie. This allows the autostereoscopic movie data to be prepared in a standard HD format pixel area both in portrait and landscape. When the number of views is selected to allow a square tiling pattern to be used, such as when four views or nine views are used, this also ensures that the resolution reduction for each view is equal in horizontal and vertical directions.

A further advantage is that high quality standard compression techniques can be used by the player software, enabling it to work on relatively low performance processing systems and play smoothly with good clarity. The use of poor quality compression techniques, as may be required if a pre-interlaced movie was provided to the player, would lead to reduced quality three-dimensional images.

Furthermore, the use of the OpenGL API provides cross-platform capability. For instance, the Mac OSX and Windows 7 operating systems fully support OpenGL. This allows users to have great flexibility in choosing the processing system hardware and operating system, whilst providing consistent smooth playback of movies with excellent clarity.

Preferably, the player software will include a graphical user interface suitable for allowing a user to initiate playback/presentation of autostereoscopic media and/or other two-dimensional media as discussed above. In one convenient form, the graphical user interface will allow the user to select one or more movies or images from an available library of such movies or images. The graphical user interface may allow selection of a plurality of media files for presentation on the autostereoscopic display. This may achieved by having the user define a playlist of media files for playback in a specified order. This can allow autostereoscopic media to be queued and displayed over an extended period of time without requiring user intervention. The user may choose to have the playlist repeat to enable media to be played for an indefinite period of time.

In one example, the graphical user interface of the player software will be focussed around the abovementioned playlist functionality, such that the queue is typically displayed to the user throughout the user's main interactions with the player software. This allows the user to conveniently access the functionality that will typically be of most interest to a user throughout normal use. Additional user option elements can be provided on screen alongside the playlist to allow the user to access other functionalities as may be required.

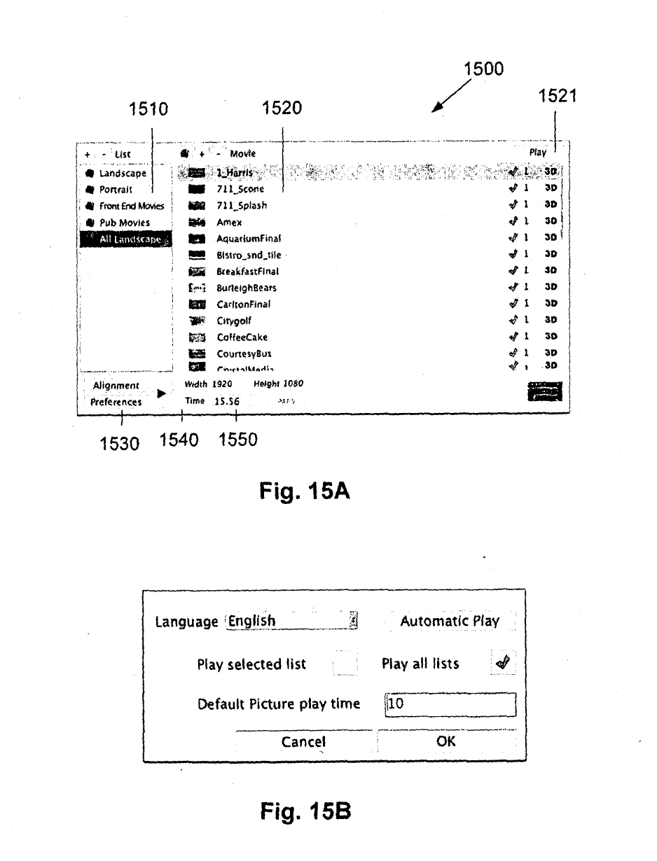

An example of a playlist window 1500 of the player software is shown in FIG. 15A.

The playlist window 1500 may include a playlist area 1510, for allowing a user to add or remove playlists and select playlists to allow editing of the selected playlist, such as by adding, removing or reordering media within that playlist. The playlist window will typically include user options for adding/removing playlists, which are provided in this case as plus/minus buttons above the playlist area 1510.

Typically, the user will also be able to manipulate the playlists using known graphical user interface techniques, such as by dragging and dropping playlists to reorder them, and double clicking the name of a playlist to rename it.

Playlists may be organised depending on whether these are configured for playback on the autostereoscopic display 110 in landscape or portrait orientation. The player software may allow the user to specify the current orientation of the autostereoscopic display 110 and use this to filter the playlists presented to the user. Alternatively, the player software may automatically detect the autostereoscopic display 110 orientation. In any case, this can prevent the display of media items which are not suitable for the current orientation. For instance, the player software may prevent a landscape format autostereoscopic movie from being played when the autostereoscopic display 110 is in a portrait orientation.

The media area 1520 allows a user to add or remove three-dimensional movies, two-dimensional movies or images to a selected playlist, and edit the playback order and other playback options for the media in the playlist.

The media area 1520 may include associated user options, such as a folder button to allow an entire folder of media to be added to a playlist in one operation. If no playlist is selected, a new playlist with the selected folder name may be created. Other typical options may include buttons for adding a single new movie or image, or removing selected items from the playlist, in this case in the form of plus/minus buttons above the media area 1520. A play button 1521 is provided to initiate playback of the playlist media displayed in the media area 1520, in the order as defined. If a particular media item is selected, playback may commence from that item when the play button 1521 is activated.

As per the playlist area 1510, the user can manipulate the media items in the media area 1520 using drag and drop interactions to change the playback order, and can select and rename media items. Furthermore, options may be provided to allow the user to include or exclude particular items when the playlist is played, without necessarily removing those items from the playlist. In the illustrated example, this is achieved by providing a check mark column, whereby the user can click on a check mark to exclude the corresponding item during play.

The media area 1520 may also include options for the user to repeat selected items in the playlist so that the item is played multiple times before playback proceeds to the next item in the sequence. In the illustrated example, a column of numbers is provided next to the check mark column, where the numbers indicate the number of times to repeat the corresponding item. The number of repetitions will default to one, but user can edit the number to cause the item to repeat a specified number of times.

Finally, the media area 1520 may also include a column indicating whether each item is a three-dimensional or two-dimensional media item (by displaying “3D” or “2D” in the column). The player software may also include a capability to allow the user to click a “3D” entry to force the media item to play as 3D media. Two-dimensional playback of an autostereoscopic movie may be achieved by taking only one of the tiled views in the movie file (typically a centre view) and mapping pixels of that view to all of the view-dependent pixels within each group of pixels underlying the microlenses 221, such that the same view will be observed from any view position.

In this example, the playlist window further includes a tool area 1530 which allows single click access to preferences, alignment pattern tools and a menu for quitting the player software and restarting or shutting down the processing system.

An alignment button may be provided which, when clicked, causes display of the first alignment pattern as shown in FIG. 10A. The user can then perform angular alignment of the optical component 220, and when this step has been completed, the user may interact with the option button 1023 (as shown on FIG. 10A) to proceed to the second alignment pattern as shown in FIG. 10B and perform horizontal alignment. The alignment patterns can be closed at any time using the close alignment button 1022, to thereby return the user to the playlist window.

The tool area 1530 may also include a preferences button which can be activated by the user to present additional player software preferences to the user, usually via a separate preferences window, an example of which is shown in FIG. 15B.

The preferences may allow selection of the language used by the player software as shown in FIG. 15B. Furthermore, a range of different playback preferences may be provided. For instance, the preferences window may include an automatic play option which can be selected to cause playback to automatically commence when the player software is started. It may be desirable to automate the execution of the player software when the processing system is turned on, so that playback immediately begins without requiring any user intervention other than providing power to the processing system.

The preferences may also allow the user to select whether to play selected or play all playlists. These options will constrain playing to the selected list or playing all lists, and will be particularly useful in the event the automatic play option is selected.

A default picture play time option may also be provided to control the duration for displaying static images. Accordingly, when an image file is added to a playlist, the default picture play time value in seconds is given by default to the imported image file. However, the default time can be overridden by editing preferences on a picture by picture basis in the playlist window as will be discussed below.

The tool area may also provide access to other menus, tool windows and the like, which may allow the user to access other functions related to the player software, to close the player software, or to restart or shut down the processing system.

An item information area 1540 may be provided on the playlist window to display information about the selected item including its width and height in pixels (i.e. the resolution of the movie or image), length in seconds and a preview thumbnail.

For static images, the length in seconds may be defined by the user using a time editing tool 1550. To change the time on an image, the user will select the image picture in the playlist and enter a new time in seconds. Movie media will simply display the movie duration without allowing the length in seconds to be edited.

For user convenience, options within the player software can also be accessed using keyboard shortcuts in accordance with typical shortcut methods, depending on the particular operating system installed on the processing system.

The player software may also interface with libraries of existing media suitable for playback on the autostereoscopic display system 100. For example, the player software may allow the user to access autostereoscopic movies in an online library. This access may be achieved using third-party online storage application software which may provide access to media via standard file transfer protocols.

Alternatively, functionality for downloading media from online libraries may be integrated into the player software, which may be accessed by selection of a download option or the like. The user may also be prompted to select a playlist to which the downloaded media can be added, such that the user would not need to manually add the media into a playlist in a separate step.

Access to particular online library content may require username and password authentication. In any case, this may provide the user with a convenient means of accessing previously prepared autostereoscopic media, removing the need to generate suitable content before being able to use the autostereoscopic display system 100.

Functionalities may also be provided to allow a user to automatically generate three-dimensional content for playback using the player software. For instance, this may be achieved by having the user define a slideshow including a plurality of images for display, and select from different animation methods that would make their images move through a three-dimensional scene. In one example, the process may be simplified using a template methodology, in which the user can select a previously prepared animation template, load an image for the background and then a plurality of images for the slideshow. A rendering process can then be carried out in accordance with the template to generate an autostereoscopic animated slideshow movie in a suitable format to be played using the player software. This would allow the user to generate suitable autostereoscopic content without requiring any particular skill in manipulating three-dimensional graphics or access to proprietary software for generating suitable content.

The above automatic content generation functionality may be incorporated into the autostereoscopic movie creation software, the player software or into separate application software. In any case, it will be appreciated that the user may also obtain suitable images, animation templates, and the like from online libraries in a similar fashion to the above described capability to download media files. The user may also be provided with the capability to upload files, thus allowing users to share layers, scenes along with generated autostereoscopic movies in a community of users.

Furthermore, the user may also be able to add a soundtrack to automatically generated autostereoscopic movies. In one example, the user may add a soundtrack and the timing of the slideshow may be automatically scaled to the length of the soundtrack, such that the resulting autostereoscopic movie and soundtrack have the same duration. This would greatly simplify the synchronisation of music and the like to the display of user-generated three-dimensional content.

In a further extension of this concept, the soundtrack may be analysed to identify beats or other significant audible events and the animation methods applied to the images in the slide show may be synchronised with those events. For example, images may be animated to vary in depth in the autostereoscopic movie in time with the beat of soundtrack music.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1. An autostereoscopic display system including:
a) an autostereoscopic display including:
i) a display panel having an arrangement of pixels; and,
ii) an optical component mounted on the display panel, the optical component including a pattern of microlenses configured to define groups of view-dependent pixels on the display panel such that light emitted from each view-dependent pixel in a group is directed to a respective viewing position relative to the display panel, wherein the optical component is mounted on the display panel using an adjustable mounting interface configured to allow adjustment of:
(1) an angular orientation of the optical component relative to the display panel; and,
(2) a horizontal position of the optical component relative to the display panel; and,
b) a processing system connected to the autostereoscopic display, the processing system being for causing autostereoscopic media to be displayed on the autostereoscopic display.

2. A system according to claim 1, wherein the mounting interface includes a frame that is fixed in relation to the display panel and a plurality of adjustable supports connected to the frame, the adjustable supports being for engaging edges of the optical component.

3. A system according to claim 2, wherein the mounting interface includes at least one of:
a) pair of lower supports for engaging a lower edge of the optical component, the pair of lower supports being vertically adjustable to allow adjustment of the angular orientation; and,
b) at least one pair of opposing side supports, the side supports being horizontally adjustable to allow adjustment of the horizontal position.

4. (canceled)

5. A system according to claim 2, wherein the adjustable supports are configured to allow independent adjustment of the horizontal position after the angular orientation has been adjusted.

6. A system according to claim 2, wherein the adjustable supports are screw supports.

7. A system according to claim 1, wherein the optical component includes a transparent substrate including surface indentations defining the pattern of microlenses, and wherein the optical component is formed as a laminate of the substrate and a layer of transparent base material.

8. (canceled)

9. A system according to claim 1, wherein the pattern of microlenses includes an array of parallel cylindrical microlenses, and wherein the cylindrical microlenses are oriented at an orientation angle relative to vertical columns of pixels of the display panel.

10. (canceled)

11. A method of configuring an autostereoscopic display, the autostereoscopic display including a display panel including an arrangement of pixels and an optical component mounted on the display, the optical component including a pattern of microlenses configured to define groups of view-dependent pixels on the display panel such that light emitted from each view-dependent pixel in a group is directed to a respective viewing position relative to the display panel, the optical component being mounted on the display panel using an adjustable mounting interface configured to allow adjustment of an angular orientation and a horizontal position of the optical component relative to the display panel, wherein the method includes:
a) using a processing system connected to the autostereoscopic display, causing a first alignment pattern to be displayed on the display panel;
b) angularly aligning the optical component in accordance with the first alignment pattern by adjusting an angular orientation of the optical component relative to the display panel;
c) using the processing system, causing a second alignment pattern to be displayed on the display panel; and,
d) horizontally aligning the optical component in accordance with the second alignment pattern by adjusting the horizontal position of the optical component relative to the display panel.

12. A method according to claim 11, wherein the first alignment pattern is configured to present a different image to a viewer depending on the angular orientation of the optical component relative to the display panel.

13. A method according to claim 12, wherein the first alignment pattern is configured to present an image including one or more bands to the viewer when the optical component is not angularly aligned in accordance with the first alignment pattern.

14. A method according to claim 13, wherein a number of bands in the image corresponds to a degree of angular misalignment.

15. A method according to claim 13, wherein the method includes adjusting the angular alignment of the optical component so that no bands are visible to the viewer.

16. A method according to claim 11, wherein the second alignment pattern includes a plurality of interlaced view frames including a central view having one or more alignment features which only become visible to a viewer at a horizontal midplane of the display panel when the optical component is horizontally aligned.

17. A method according to claim 16, wherein the method includes adjusting the horizontal alignment of the optical component so that the alignment features become visible to the viewer at the horizontal midplane of the display panel.

18. A method according to claim 16, wherein the second alignment pattern includes four alignment features positioned proximate to respective corners of the display panel and a fifth alignment feature positioned substantially centrally on the display panel.

19. A method of displaying an autostereoscopic movie on an autostereoscopic display, the autostereoscopic display including a display panel including an arrangement of pixels and an optical component mounted on the display, the optical component including a pattern of microlenses configured to define groups of view-dependent pixels on the display panel such that light emitted from each view-dependent pixel in a group is directed to a respective viewing position relative to the display panel, the method including, in a processing system:
a) receiving an autostereoscopic movie including a plurality of frames, each frame of the movie including a tiled pattern of a plurality of view frames corresponding to respective
b) views of a three dimensional scene taken from offset view positions; and, for each frame:
iii) processing the frame to extract each of the plurality of view frames;
iv) interlacing the plurality of view frames to provide an interlaced frame by mapping pixels from each view frame to a respective view-dependent pixels on the display panel; and,
v) rendering the interlaced frame on the autostereoscopic display.

20. A method according to claim 19, wherein the received autostereoscopic movie is compressed and the method further includes decompressing each frame of the movie prior to extracting the view frames, and wherein each frame is decompressed and the view frames are extracted using a central processing unit of the processing system.

21-22. (canceled)

23. A method according to claim 19, wherein the view frames are interlaced and the interlaced frame is rendered using a graphics processing unit of the processing system.

24. A method according to claim 19, wherein the method further includes, in the processing system:
a) receiving additional text or image data;
b) generating three dimensional geometry using the text or image data;
c) generating a plurality of views of the three dimensional geometry corresponding to the plurality of views of each frame in the movie; and,
d) superimposing the views of the three dimensional geometry onto corresponding extracted view frames of the movie.

25. A method according to claim 19, wherein the received autostereoscopic movie has a resolution equal to a resolution of the display panel of the autostereoscopic display.

26-28. (canceled)
